(19) United States
(12) Patent Application Publication
(10) Pub. No.: US 2018/0252366 A1
(43) Pub. Date: Sep. 6, 2018

(54) FOOT-IN-FOOT MOUNTING OF CRYOGENIC STORAGE CONTAINERS

(71) Applicant: LINDE AKTIENGESELLSCHAFT, Muenchen (DE)

(72) Inventors: Heinz POSSELT, Bad Aibling (DE); Juergen BICHLMEIER, Tacherting (DE); Florian EHEGARTNER, Neuotting (DE); Stefan FELBINGER, Ampfing (DE); Adriana STEFANESCU, Muenchen (DE)

(73) Assignee: LINDE AKTIENGESELLSCHAFT, Muenchen (DE)

(21) Appl. No.: 15/753,867

(22) PCT Filed: Aug. 18, 2016
(86) PCT No.: PCT/EP2016/001409

§ 371 Date: Feb. 20, 2018

(30) Foreign Application Priority Data
Aug. 20, 2015 (EP) 15002471.9

(51) Int. Cl. F17C 13/00; F17C 1/12; F17C 13/08

(52) U.S. Cl. CPC F17C 13/001; F17C 1/12; F17C 13/08; F17C 2201/0109; F17C 2203/0629; F17C 2205/018; F17C 2205/0192; F17C 2203/0337

(57) ABSTRACT

A storage container for cryogenic liquids comprising an inner container which encloses a volume for receiving a fluid medium, an outer container which encloses a volume in which the inner container is arranged, with the result that an interspace is formed between the inner container and the outer container, and wherein the outer container has at least one outerfoot by means of which the storage container can be supported on an underlying surface, wherein the at least one outerfoot takes the form of a hollow body, and wherein the inner container has at least one inner foot for supporting the inner container that projects into the interior of the at least one outer foot.

The invention relates to a storage container for fluid media, in particular cryogenic liquids.

Storage containers of this type generally take the form of double-shell containers and correspondingly have an inner container with an inner container shell, which bounds an inner container volume for receiving the fluid medium, and also an outer container with an outer container shell, which bounds an outer container volume in which the inner container is arranged, so that a first interspace is formed between an outer side of the inner container shell and an inner side of the outer container shell. For supporting the storage container on a horizontally running underlying surface, the outer container has at least one outer container foot, with which the storage container rests on the underlying surface.

Such a storage container is disclosed for example by U.S. Pat. No. 3,115,983, in which the inner container is suspended from the outer container, so that the load of the inner container is introduced into the foundation or the underlying surface via the outer container and its feet. JP2012-112474 A also discloses a storage container, in which the load of the inner container is likewise introduced into the underlying surface via the entire outer container foot.

In the case of a fire, the modulus of elasticity of the outer container often falls. As a result, it is no longer stable. A resultant tipping over or structural failure of the outer container is then most likely accompanied by a corresponding failure of the inner container. Under some circumstances, this can cause the cryogenic medium that is being stored to escape and cause further damage. In the case of flammable media, the fire is exacerbated.

Furthermore, in the case of cryogenic containers, the inner container often shrinks while it is cooling down. This produces additional loads on the inner container.

In particular in the case of an earthquake, the entire container forms a single-mass oscillator, producing high additional loads for the mounting of the inner container and outer container.

The invention is therefore based on the object of providing a storage container that is improved with regard to the aforementioned problem area.

This problem is solved by a storage container with the features of claim 1. Advantageous configurations of the invention are provided in the subclaims and are described below.

According to claim 1, it is provided according to the invention that the storage container has a guide, which is designed to guide the at least one inner container foot, wherein the guide has two guiding bodies, which protrude from the base of the at least one outer container foot, wherein the inner container foot is arranged between the two guiding bodies, so that it can be guided along the guiding bodies by the latter.

This results in lower loads on the inner container when the inner container shrinks and lower loads on the foundation in the load case of an earthquake.

Furthermore, the at least one inner container foot can be advantageously guided in the downward direction in the at least one outer container foot, so that as little load as possible of the inner container is diverted away via the at least one outer container foot or outer container. In particular in the load case of a fire, the outer container can consequently support itself on the inner container if there is a failure of its stability.

According to a preferred embodiment of the invention, it is provided that the sliding bearing has an upper first surface, which is fixed on or assigned to the at least one inner container foot, and also a (lower) second surface, which is fixed on or assigned to the base of the outer container foot concerned, wherein the first surface is designed to slide (for example directly) on the second surface.

According to one embodiment of the invention, a lubricant (for example graphite) is provided between the two surfaces. With an appropriate pairing of materials, the two surfaces may however also slide directly on one another without lubricant.

The first surface may be formed by an underside of the at least one inner container foot. The first surface may in this case be formed by a coating of the underside (for example PTFE).

Furthermore, the sliding bearing may also have a sliding bearing body, which is fixed on the underside of the at least one inner container foot and then forms the first surface (for example in the form of a coating or a layer of material).

Furthermore, the second surface may be formed by an upper side of the base. The second surface may in this case be formed by a coating of the upper side of the base (for example PTFE).

Furthermore, the sliding bearing may have a further sliding bearing body, which is fixed on an upper side of the base and forms the second surface (for example in the form of a coating or a layer of material).

One of the two surfaces may be formed in particular from a steel, while the other surface may comprise PTFE.

The two surfaces may also be formed in each case by a steel, in particular different steels (i.e. the steel of the first surface differs from the steel of the second surface), wherein a lubricant may be arranged between the surfaces.

The sliding bearing or bearings allow(s) the inner container foot or feet to move in the horizontal plane with respect to the outer container.

It is preferably provided that the at least one sliding bearing has a coefficient of sliding friction that is less than or equal to 0.1. The coefficient of sliding friction is defined here as the ratio of the sliding frictional force to the normal force with which the respective inner container foot presses onto the base of the assigned outer container foot. A higher coefficient of friction therefore means a greater frictional force.

As already explained, it is provided that the storage container has a guide, which is preferably designed to guide the at least one inner container foot when there is temperature-induced shrinkage or expansion, to be precise preferably in or counter to a radial direction of the inner container that is perpendicular to a longitudinal axis of the inner container or inner container shell and is directed away from said axis to the inner container foot.

As also already explained above, the guide has two guiding bodies, which for example protrude from the base of the at least one outer container foot, wherein the inner container foot is arranged between the two guiding bodies, so that it can be guided horizontally along the guiding bodies by the latter. The two guiding bodies preferably extend on both sides of the at least one inner container foot parallel to said radial direction, so that the at least one inner container foot is guided in or counter to this radial direction when there is temperature-induced shrinkage or expansion.

This guide makes it possible for the inner container to stand stably in such a way as to allow temperature-induced movements of the inner container, during which it slides on the sliding bearing described above.

Preferably, the at least one outer container foot is closed in the downward direction by a base, which is designed for supporting the at least one outer container foot on the underlying surface, that is to say forms a standing area of the at least one outer container foot by way of which the at least one outer container foot contacts the underlying surface on which the storage container is set up.

According to a preferred embodiment of the invention, it is provided that between an outer side of the at least one inner container foot and an inner side of the at least one outer container foot there is formed a second interspace, which is connected to the first interspace, i.e. goes over into it. This creates the possibility of also providing an insulating means between the two feet, which may also be provided in the first interspace between the outer container and the inner container. Preferably, therefore, that second interspace surrounds the inner container foot, i.e. runs around it in a circumferential direction of the inner container foot.

It is preferably also provided that the insulating means partially or completely fills the first and/or second interspace. In particular in the case of a multilayer insulation, the first and/or second interspace is only partially filled.

According to a preferred embodiment, it is provided that the at least one outer container foot is formed as hollow-cylindrical in the general sense. The outer container foot may in this case have various base areas or cross-sectional shapes, for example circular (hollow-circular cylinder), triangular, rectangular, square, hexagonal, or any other cross-sectional shape. The assigned, at least one inner container foot may in this case be arranged coaxially with respect to the at least one outer container foot.

According to a preferred embodiment of the invention, it is also provided that the at least one outer container foot protrudes from the outer container shell, in particular from a base of the outer container shell, to be precise preferably along the vertical or the longitudinal axis of the outer container or outer container shell, wherein in particular the at least one outer container foot is fixed by a running-around peripheral region on a running-around peripheral region of an assigned through-opening of the outer container shell or of the base of the outer container shell, for example by means of a welded connection, the two interspaces being connected to one another by way of that through-opening.

According to a preferred embodiment of the invention, it is also provided that the at least one inner container foot supports itself by an underside, which forms a standing area of the at least one inner container foot, on an upper side of the base of the assigned outer container foot, wherein the at least one inner container foot preferably only contacts the at least one outer container foot with its underside or standing area, to be precise preferably only the base of the at least one outer container foot. The latter is very stable as a result of its comparatively small overall height, and preferably lies flat on the underlying surface, so that the load of the inner container is advantageously only diverted away into the underlying surface via the base of the at least one hollow outer container foot. Consequently, the outer container can if need be also be supported by way of the inner container.

The at least one inner container foot itself is preferably fixed on the inner container shell, in particular on a base of the inner container shell, to be precise preferably by an end region of the at least one inner container foot that is opposite from that underside/standing area of the inner container foot, or by way of a bracket/attachment weld of a vertical area on the shell.

The at least one inner container foot likewise preferably extends along the vertical or along the longitudinal axis of the inner container, while the respective inner container foot may also have an inclination or stand obliquely.

Furthermore, the inner container shell and the outer container shell are preferably arranged coaxially in relation to one another.

The storage container according to the invention may also have any desired number of outer container feet and assigned inner container feet (for example four such foot-in-foot arrangements). A sliding bearing according to the invention is then preferably provided between each inner container foot and the respectively assigned outer container foot. Furthermore, all of the inner container feet may have a guide of the type described above.

It is also possible that the storage container only has one outer container foot and an assigned inner container foot. The outer container foot may in this case have a running-around, for example annular, interior space, into which there protrudes the inner container foot, which may likewise be formed as running around (for example in the form of a supporting skirt). The sliding bearing may then be correspondingly formed as annular.

Further features and advantages are to be explained in the following description of the figures of an exemplary embodiment of the invention on the basis of the figure, in which:

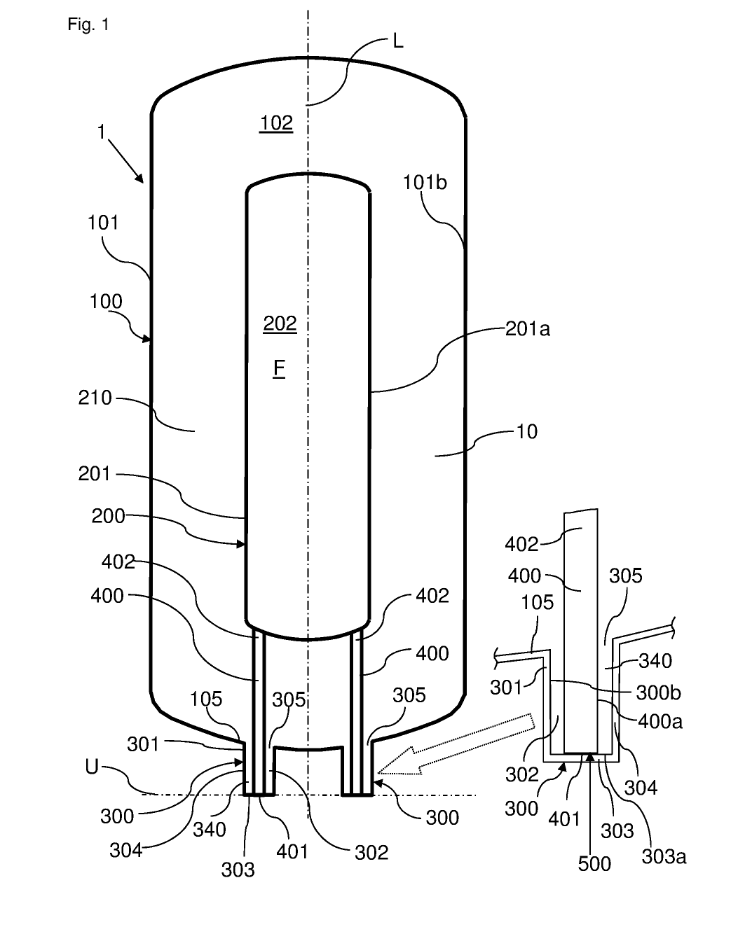

FIG. 1 shows a schematic sectional representation of a storage container according to the invention for a fluid medium and also a detail of the sectional representation that shows the outer container foot and the inner container foot arranged therein in an enlargement;

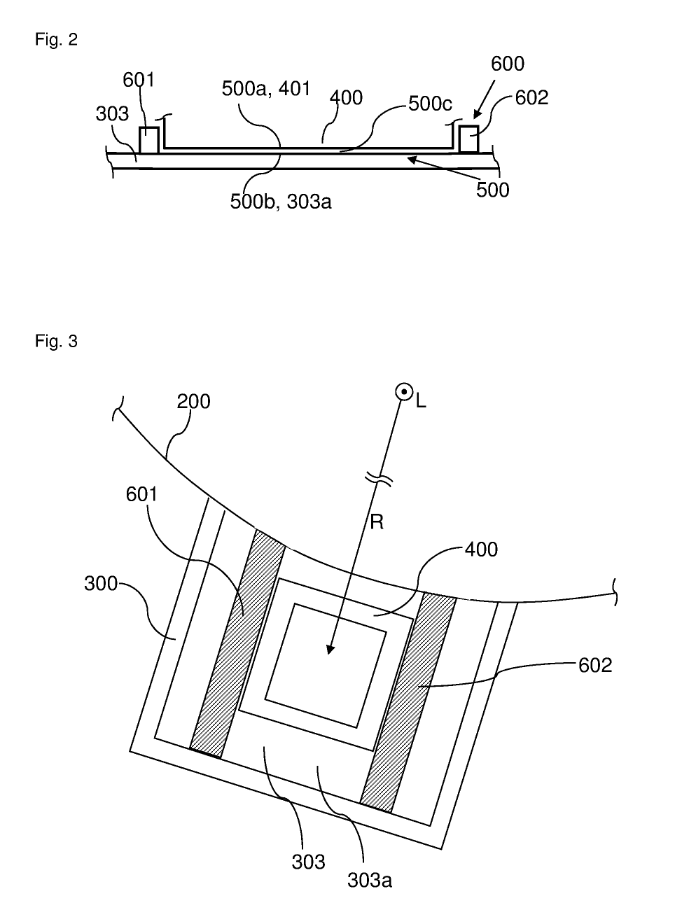

FIG. 2 shows a further detail of FIG. 1 that shows the sliding mounting according to the invention of an inner container foot; and

FIG. 3 shows a schematic plan view of a guide for an inner container foot.

FIG. 1 shows a schematic sectional view of a storage container 1 for fluid media, in particular cryogenic liquids. The storage container 1 has an outer container 100, with an outer container shell 101, which extends along a longitudinal axis L, which runs parallel to the vertical when the storage container 1 is set up as intended. The storage container 1 may also be a lying or horizontal container, in the case of which the longitudinal axis L runs along the horizontal. The outer container shell 101 bounds an outer container volume 102, arranged in which is an inner container 200 of the storage container 1, which is designed for receiving or for storing a fluid medium F, for example in the form of a cryogenic liquid. The inner container 200 has in turn an inner container shell 201, which bounds an inner container volume 202, into which the fluid medium F to be stored is introduced. The inner container shell 201 likewise extends along a longitudinal axis L and is preferably arranged coaxially in relation to the outer container shell 101. The common longitudinal axis L may form a cylinder axis of the two shells 101, 201.

The inner container 200 is preferably arranged in the outer container 100 in such a way as to create between an outwardly facing outer side 201a of the inner container shell 201 and an inner side 101b of the outer container shell 101 that is facing the inner container shell 201 an interspace 210, which runs around the inner container 200 and in which an insulating means 10 is provided in order to reduce the transfer of outside heat to the medium F stored in the inner container volume 202. Perlite or rocks, glass bubbles (hollow glass beads), multilayer insulating means (that is to say insulating means comprising a number of layers), other bulk materials or else fluid insulating means may be used for example as insulating means.

For setting up the storage container 1 on a horizontal underlying surface or foundation U, the outer container 200 has an outer container foot 300 (see above) or a plurality of outer container feet 300, for example four such feet 300, two such outer container feet 300 being shown in the section according to FIG. 1.

The respective outer container foot 300 is then formed as a hollow body which is open on one side and surrounds an interior space 302 of the respective outer container foot 300. In this case, the respective outer container foot 300 may be formed as hollow-cylindrical and has a base 303, by which the storage container 1 or the respective outer container foot 300 rests on the underlying surface U, wherein from the base 303 of the respective outer container foot 300 there protrudes a running-around side wall 304, which has a running-around upper peripheral region 301, by way of which the respective outer container foot 300 is fixed on a lower region or base of the outer container shell 101 (for example by way of a welded connection). In this case, that running-around peripheral region 301 of the respective outer container foot 300 is fixed on a running-around peripheral region 105 of a through-opening 305 of the outer container shell 101 or of the base of the outer container shell, so that the interior space 302 or the second interspace 340 (see below) of the respective outer container foot 300 is connected to or goes over into the first interspace 210 by way of the respective through-opening 305. The respective outer container foot 300 or its side wall 304 in this case protrudes from the lower region or base of the outer container shell 101 along the longitudinal axis L in the direction of the underlying surface U.

The inner container 200 then has for its part a number of inner container feet 400 corresponding to the number of outer container feet 300, which inner container feet respectively extend along the longitudinal axis L and are fixed on a lower region of the inner container shell 201 or on a base of the inner container shell 201 by way of an end region 402. Each inner container foot 400 then extends from the inner container shell 201 or base into the interior space 302 of an assigned outer container foot 300 and thereby supports itself on the horizontally running base 303 of the assigned outer container foot 300 by way of a sliding bearing 500.

According to FIG. 2, the respective sliding bearing has an upper first surface 500a, which may be provided on said underside 401 of the inner container foot concerned, and also a lower second surface 500b, which may be provided on an upper side 303a of the base 303 of the corresponding outer container foot 300.

Here, the respective first surface 500a is designed to rest on the respectively assigned second surface 500b or to slide on it (in the horizontal plane). If appropriate, a lubricant 500c may be provided here between the two surfaces 500a, 500b. With a suitable pairing of materials, it is also possible however to dispense with a separate lubricant 500c (for example if one of the surfaces is formed by PTFE and the other by a steel). The sliding bearings 500 formed in this way preferably have in each case a coefficient of sliding friction that is less than or equal to 0.1. Of course, each of the two surfaces 500a, 500b may also each be formed by separate sliding body, which is then fixed on the inner container foot 400 or on the outer container foot 300 (for example base 303).

According to FIGS. 2 and 3, the storage container 1 may have for each inner container foot 400 a guide 600, which is designed to guide the respective inner container foot 400 in the radial direction R when there is temperature-induced shrinkage or expansion of the inner container 200. The respective radial direction R is in this case directed from the longitudinal axis L to the respective inner container foot 400 and is in this case perpendicular to the longitudinal axis L. The respective guide 600 may have for this purpose two guiding bodies 601, 602, which are made to extend parallel to the radial direction and preferably protrude in the vertical direction from the base 303 of the respective outer container foot 301, wherein the respective inner container foot 400 is arranged between the two guiding bodies 601, 602, so that it can be guided along the guiding bodies 601, 602 in or counter to the radial direction R.

The inner container feet 400 slidingly mounted in such a way in each case run in the respectively assigned outer container foot 300. In this case there is between an outwardly facing outer side 400a of the respective inner container foot 400 and an inner side 300b of the assigned outer container foot 300 that is facing the respective inner container foot 400 a second interspace 340, which surrounds the respective inner container foot 400 and goes over into the first interspace 210 by way of the respective through-opening 305. The first interspaces 340 may of course also be filled with the (or some other) insulating means 10. The outer container feet 300 may of course also be integrally formed in one piece on the outer container shell 101.

The arrangement according to the invention of the feet 300, 400 consequently makes it possible that, in the event of structural failure, the outer container 100 can support itself on the inner container 200, via which the load can then be introduced into the underlying surface U, wherein furthermore, as a result of the sliding mounting, lower loads act on the inner container 200 when the inner container 200 shrinks and the loads on the foundation are reduced in the load case of an earthquake.

List of reference numerals

| | |
|---|---|
| 1 | Storage container |
| 10 | Insulating means |
| 100 | Outer container |
| 101 | Outer container shell |
| 101b | Inner side |
| 102 | Outer container volume |
| 105 | Peripheral region |
| 200 | Inner container |
| 201 | Inner container shell |
| 201a | Outer side |
| 202 | Inner container volume |
| 210 | First interspace |
| 300 | Outer container foot |
| 300b | Inner side |
| 301 | Peripheral region |
| 302 | Interior space |
| 303 | Base |
| 303a | Upper side |
| 304 | Side wall |
| 305 | Through-opening |
| 340 | Second interspace |
| 400 | Inner container foot |
| 400a | Outer side |
| 401 | Underside or standing area |
| 402 | End region |
| 500 | Sliding bearing |
| 500a, 500b | Surface |
| 500c | Lubricant |
| 600 | Guide |
| 601, 602 | Guiding body |
| F | Fluid medium |
| L | Longitudinal axis or vertical |

1. A storage container for fluid media, in particular cryogenic liquids, having:
an inner container (200) with an inner container shell (201), which encloses an inner container volume (202) for receiving a fluid medium (F),
and also an outer container (100) with an outer container shell (101), which encloses an outer container volume (102) in which the inner container (200) is arranged, so that a first interspace (210) is formed between an outer side (201a) of the inner container shell (200) and an inner side (101b) of the outer container shell (101), and
wherein the outer container (100) has at least one outer container foot (300), with which the storage container (1) can be supported on an underlying surface (U), and
wherein the at least one outer container foot (300) is formed as a hollow body, which surrounds an interior space (302) of the at least one outer container foot (300), wherein the inner container (200) has at least one inner container foot (400) for supporting the inner container (200), which protrudes into that interior space (302) of the at least one outer container foot (300), and
wherein the at least one inner container foot (400) is mounted on a base (303) of the at least one outer container foot (300) by way of a sliding bearing (500),
characterized
in that the storage container (1) has a guide (600), which is designed to guide the at least one inner container foot (400), wherein the guide (600) has two guiding bodies (601, 602), which protrude from the base (303) of the at least one outer container foot (300), wherein the inner container foot (400) is arranged between the two guiding bodies (601, 602), so that it can be guided along the guiding bodies (601, 602) by the latter.

2. The storage container as claimed in claim 1, characterized in that the sliding bearing (500) has a first surface (500a), which is fixed on the at least one inner container foot (400), and also a second surface (500b), which is fixed on the base (303), wherein the first surface (500a) is designed to slide on the second surface (500b).

3. The storage container as claimed in claim 2, characterized in that a lubricant (500c) is provided between the two surfaces (500a, 500b).

4. The storage container as claimed in claim 1, characterized in that the sliding bearing (500) has a coefficient of sliding friction that is less than or equal to 0.1

5. The storage container as claimed in claim 1, characterized in that the at least one outer container foot (300) is closed in the downward direction by the base (303), wherein the base (303) is designed for supporting the at least one outer container foot (300) on the underlying surface (U).

6. The storage container as claimed claim 1, characterized in that between an outer side (400a) of the at least one inner container foot (400) and an inner side (300b) of the at least one outer container foot (300) there is formed a second interspace (340), which is connected to the first interspace (210).

7. The storage container as claimed in claim 6, characterized in that that second interspace (340) surrounds the at least one inner container foot (400).

8. The storage container as claimed claim 1, characterized in that an insulating means (10) is arranged in the first interspace (210) and/or the second interspace (340), wherein in particular the insulating means (10) completely fills the first and/or second interspace (210, 340).

9. The storage container as claimed in claim 1, characterized in that the at least one outer container foot (300) is formed as hollow-cylindrical.

10. The storage container as claimed in claim 1, characterized in that the at least one outer container foot (300) protrudes from the outer container shell (101), wherein in particular the at least one outer container foot (300) is fixed by a running-around peripheral region (301) on a running-around peripheral region (105) of a through-opening (305) of the outer container shell (101).

11. The storage container as claimed in claim 1, characterized in that the at least one inner container foot (400) is fixed on the inner container shell (201), in particular by an end region (402) of the at least one inner container foot (400) that is opposite from that underside (401).
